(19) United States
(12) Patent Application Publication
(10) Pub. No.: US 2013/0177772 A1
(43) Pub. Date: Jul. 11, 2013

(54) RADIATION MITIGATED ARTICLES AND METHODS OF MAKING THE SAME

(71) Applicants: Jon Conrad Schaeffer, Simpsonville, SC (US); Stephen Gerard Pope, Roebuck, SC (US)

(72) Inventors: Jon Conrad Schaeffer, Simpsonville, SC (US); Stephen Gerard Pope, Roebuck, SC (US)

(73) Assignee: GENERAL ELECTRIC COMPANY, Schenectady, NY (US)

(21) Appl. No.: 13/344,211

(22) Filed: Jan. 5, 2012

(51) Int. Cl. B32B 17/06; E04B 1/74; B32B 9/00; B05D 1/36; B32B 18/00; B32B 15/04

(52) U.S. Cl. 428/426; 428/446; 428/457; 428/698; 428/702; 427/402; 427/419.6; 427/419.1; 252/62

(57) ABSTRACT

Articles comprising a substrate; a thermal barrier coating disposed on the substrate, the thermal barrier coating comprising a radioactive element, the radioactive element having a base radiation emission; and a radiation inhibitor disposed in or on the thermal barrier coating, or a combination thereof, the thermal barrier coating and radiation inhibitor having a mitigated radiation emission, wherein the mitigated radiation emission is lower than the base radiation emission and a methods of making the same.

### BACKGROUND OF THE INVENTION

The subject matter disclosed herein generally relates to articles, such as gas turbine engine components, and more particularly, to articles which mitigate, or inhibit, radiation produced by the materials used in the manufacture of thermal barrier coatings and methods of making the same.

Thermal barrier coatings are used in power generation devices such as gas turbine engines to thermally insulate structural engine components during operation of the engines at high temperatures. Thermal barrier coatings and other ceramic materials in power generation devices can contain uranium, thorium and other elements capable of emitting radiation. The types of radiation emitted by these elements include alpha, beta and gamma radiation particle emissions.

As industry regulations to limit radiation emissions from gas turbine engines and components become more stringent, the desire to mitigate, or inhibit, radiation from being emitted by radioactive elements in the thermal barrier coating and other ceramic materials has increased. Managing radiation emissions can increase the time and frequency of operating service intervals, decrease the usefulness and life and increase the costs associated with maintaining or replacing the engine components. One approach to meeting more stringent industry radiation emission limits is to use pure ceramic materials in the thermal barrier coating from which radioactive elements such as uranium and thorium have been partially or completely removed. This removal approach can be cost-prohibitive.

It is therefore desirable to provide articles and methods for making the articles that mitigate the radiation emitted from radioactive elements present in thermal barrier coatings and other ceramic materials.

### BRIEF DESCRIPTION OF THE INVENTION

Disclosed herein, and according to an aspect of the present invention, is an article comprising a substrate; a thermal barrier coating disposed on the substrate, the thermal barrier coating comprising a radioactive element, the radioactive element having a base radiation emission; and a radiation inhibitor disposed in or on the thermal barrier coating, or a combination thereof, the thermal barrier coating and radiation inhibitor having a mitigated radiation emission, wherein the mitigated radiation emission is lower than the base radiation emission.

Disclosed herein too, and according to another aspect of the present invention, is a method of making an article, comprising providing an article comprising a substrate; disposing a thermal barrier coating on the substrate, the thermal barrier coating comprising a radioactive element, the radioactive element having a base radiation emission; and disposing a radiation inhibitor in or on the thermal barrier coating, or a combination thereof, the thermal barrier coating and inhibitor having a mitigated radiation emission, wherein the mitigated radiation emission is lower than the base radiation emission.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a partial cross-sectional view of a gas turbine component;

FIG. 2 is a partial cross-sectional view of another gas turbine engine component;

FIG. 3 is a partial cross-sectional view of another gas turbine engine component;

FIG. 4 is a partial cross-sectional view of another gas turbine engine component; and

FIG. 5 is a partial cross-sectional view of another gas turbine engine component.

The detailed description explains embodiments of the invention, together with advantages and features, by way of example with reference to the drawings.

### DETAILED DESCRIPTION

Embodiments described herein generally relate to radiation mitigated articles and methods for making the same. Radiation inhibitors are provided that are used in conjunction with thermal barrier coatings and other ceramic materials. The radiation inhibitors are used in conjunction with new thermal barrier coatings and existing thermal barrier coatings after a predetermined operating service interval, and are disposed in or on thermal barrier coatings, or a combination thereof. The embodiments and articles described hereafter are described in conjunction with a gas turbine engine and components thereof; however, it is to be understood that the embodiments also apply to any power generation device that benefits from one or more aspects of the present invention, including but not limited to, turbine engines, steam turbine engines, turbomachines, and components thereof.

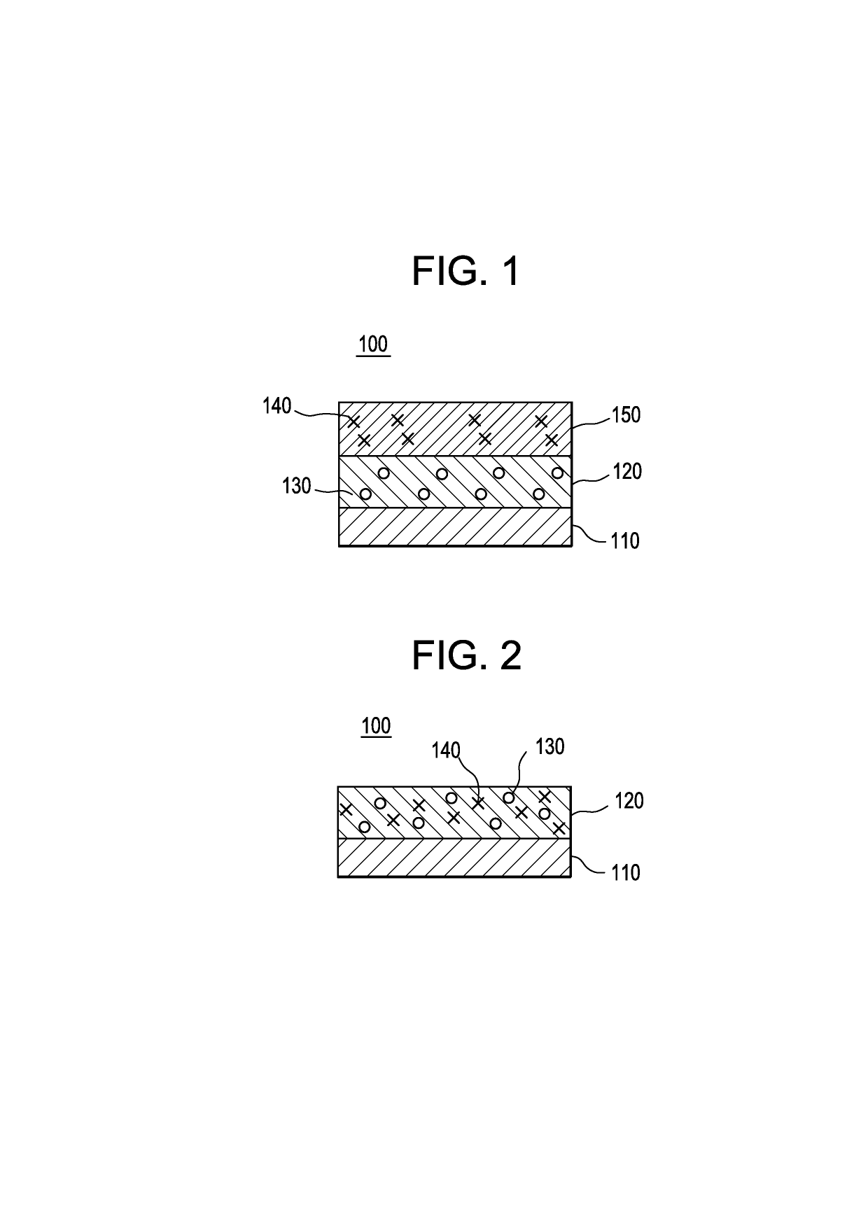

With reference to FIG. 1, an article comprising a gas turbine engine component 100 comprises a component substrate 110 comprising a high temperature material. The high temperature material is a material capable of withstanding gas turbine engine operating temperatures of from about 1000° C. to about 2000° C. The gas turbine engine component 100 and component substrate 110 is a component of a gas turbine engine which can be thermally insulating, more specifically, a turbine blade, vane, shroud, liner, combustor, transition piece, rotor component, exhaust flap, seal, fuel nozzle, and the like.

The gas turbine engine component 100 also comprises a thermal barrier coating 120 disposed on the component substrate 110. The thermal barrier coating 120 comprises a radioactive element 130, where the radioactive element has a base radiation emission. The gas turbine engine component 100 further comprises a radiation inhibitor 140 disposed on the thermal barrier coating 120. In some embodiments, the radiation inhibitor 140 further comprises a coating layer 150 disposed on the thermal barrier coating. The thermal barrier coating 120 and radiation inhibitor 140 have a mitigated radiation emission, wherein the mitigated radiation emission is lower than the base radiation emission. Specifically, the mitigated radiation emission is up to about 99% lower than the base radiation emission. More specifically, the mitigated radiation is up to about 75% to 95% lower than the base radiation emission.

In one aspect of the exemplary embodiment, the radioactive element 130 is any element present in the thermal barrier coating 120 that is capable of emitting radioactive particles. More specifically, the radioactive element 130 is a radioactive isotope of uranium, thorium, a refractory metal, a transition metal or a combination including at least one of the foregoing. Examples of refractory metals include but are not limited to tantalum, rhenium, molybdenum, and tungsten. Examples of transition metals include but are not limited to nickel, chromium, cobalt, gold, and molybdenum. The radioactive element 130 emits radioactive particles comprising alpha, beta, gamma or other types of radiation.

In another aspect of the exemplary embodiment, the radiation inhibitor 140 is any material capable of mitigating or inhibiting radiation from the radioactive element 130 in the thermal barrier coating 120. More specifically, the radiation inhibitor 140 absorbs, chemically reacts with or attaches to the radioactive particles emitted by the radioactive element 130, or a combination thereof. In some embodiments, the radiation inhibitor 140 further comprises a coating layer 150 comprising a ceramic material, a glass material, a gamma radiation absorber or a combination comprising at least one of the foregoing, capable of absorbing alpha, beta or gamma radiation, or a combination comprising at least one of the foregoing. In particular, any of the foregoing materials acts as a radiation shield or an alpha radiation absorber, or a combination comprising at least one of the foregoing. The radiation inhibitor coating layer 150 is disposed on the thermal barrier coating 120 or disposed on any intervening coating or layer disposed on the thermal barrier coating 120.

Suitable ceramic materials include, but are not limited to, ceramic metals, ceramic metal oxides, or a combination comprising at least one of the foregoing. Specifically, the ceramic metal is aluminum, calcium, cerium, barium, titanium, bismuth, gadolinium, boron, iron, lead, magnesium, silicon, uranium, yttrium, ytterbium, zinc, hafnium, zirconium or a combination comprising at least one of the foregoing. Other examples of ceramic materials include silicon carbide, silicon nitride, silica and mullite. Examples of suitable ceramic coating compositions can include, but are not limited to, a monolithic ceramic coating, a ceramic matrix coating (CMC) a sintered ceramic coating, an oxide matrix coating (OMC), a low thermal conductivity ceramic coating, an ultra-low thermal conductivity ceramic coating or a combination comprising at least one of the foregoing or multiple layers thereof.

In an aspect of the exemplary embodiment, the ceramic material is yttria stabilized zirconia, gadolinium doped yttria stabilized zirconia, ytterbium zirconate or a combination of at least one of the foregoing. In another aspect of the exemplary embodiment, the ceramic material comprises a lower thorium or uranium content than the thermal barrier coating 120, or both. In a more specific aspect of the exemplary embodiment, the yttria stabilized zirconia comprises a lower thorium or uranium content than the thermal barrier coating 120, or both. In another specific aspect of the exemplary embodiment, the ceramic material comprises zirconia and hafnium. Suitable glass materials include, but are not limited to, silica-based materials.

In another aspect of the exemplary embodiment, the radiation inhibitor coating layer 150 comprises a ceramic material wherein the ceramic material is a calcium magnesium aluminosilicate (CMAS) mitigation composition. The CMAS mitigation composition comprises zinc aluminate spinel (ZnAl₂O₄), alkaline earth zirconates (AeZrO₃), alkaline earth hafnates (AeHfO₃), rare earth gallates (Ln₃Ga₅O₁₂, Lna₄Ga₂O₉), beryl, or a combination comprising at least one of the foregoing.

As used herein, “alkaline earth” or “Ae” represents the alkaline earth elements of magnesium (Mg), calcium (Ca), strontium (Sr), barium (Ba), or a combination comprising at least one of the foregoing. Additionally, as used herein throughout, “Ln” refers to the rare earth elements of scandium (Sc), yttrium (Y), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), or a combination comprising at least one of the foregoing, while “Lna” refers to the rare earth elements of lanthanum (La), cerium (Ce), praseodymium (Pr), neodymium (Nd), promethium (Pm), samarium (Sm), europium (Eu), gadolinium (Gd), or a combination comprising at least one of the foregoing.

Suitable gamma radiation absorbers comprise a chemical element having an atomic number equal to or greater than the atomic number of barium. More specifically, the gamma radiation absorber comprises barium, bismuth, hafnium, lead, strontium, tungsten, uranium or a combination comprising at least one of the foregoing. In an aspect of the exemplary embodiment, the gamma radiation absorber further comprises a compound comprising boron, oxygen, nitrogen, carbon, silicon or a combination comprising at least one of the foregoing. In another aspect of the exemplary embodiment, the radiation inhibitor coating layer 150 comprises a hafnium gamma radiation absorber and a yttria stabilized zirconium ceramic material.

In an aspect of the exemplary embodiment, the radiation inhibitor 140 comprises particles or nanoparticles. The particles have an average particle diameter of about 1 micron to about 1,000 microns, specifically about 10 microns to about 800 microns, more specifically about 20 microns to about 400 microns. The nanoparticles have an average particle diameter of about 100 nanometers to about 1,000 nanometers, specifically about 250 nanometers to about 750 nanometers, more specifically about 400 nanometers to about 600 nanometers.

In another aspect of the exemplary embodiment, the radiation inhibitor 140 comprises two or more coating layers 150 comprising any of the radiation inhibitor materials described herein, or a combination comprising at least one of the foregoing.

In another aspect of the embodiment, additional coatings or layers are disposed between the component substrate 110 and the thermal barrier coating 120, or disposed on the thermal barrier coating 120 between the thermal barrier coating 120 and the radiation inhibitor coating layer 150, or are disposed on the radiation inhibitor coating layer 150.

The radiation inhibitor coating layer 150 is applied by any conventional means. Specifically, the radiation inhibitor 140 is coated as a separate layer, a grain boundary phase, or discrete, dispersed refractory particles or nanoparticles. Such conventional methods generally include, but should not be limited to, plasma spraying, high velocity plasma spraying, low pressure plasma spraying, solution plasma spraying, suspension plasma spraying, chemical vapor deposition (CVD), electron beam physical vapor deposition (EBPVD), sol-gel, sputtering, slurry processes such as dipping, spraying, tape-casting, rolling, and painting, and combinations of these methods. Once coated, the radiation inhibitor coating layer 150 is dried and sintered using either conventional methods, or unconventional methods such as microwave sintering, laser sintering or infrared sintering. The radiation inhibitor coating layer 150 disposed on the thermal barrier coating 120 has a thickness of from about 0.05 mm to about 5.0 mm, specifically from about 0.1 mm to about 1 mm.

In other exemplary embodiments, the radiation inhibitor comprises a material comprising a gamma radiation absorber disposed in and/or on the thermal barrier coating. Referring to FIG. 2, in one aspect of the exemplary embodiment, the radiation inhibitor 140 comprises a gamma radiation absorber disposed in the thermal barrier coating 120. The radiation inhibitor 140 absorbs gamma radiation from the radioactive element 130 or reacts with or attaches to the radioactive element 130, or a combination of at least one of the foregoing. The radiation inhibitor 140 comprising a gamma radiation absorber is disposed in the thermal barrier coating 120 by any conventional method, including but not limited to dispersion.

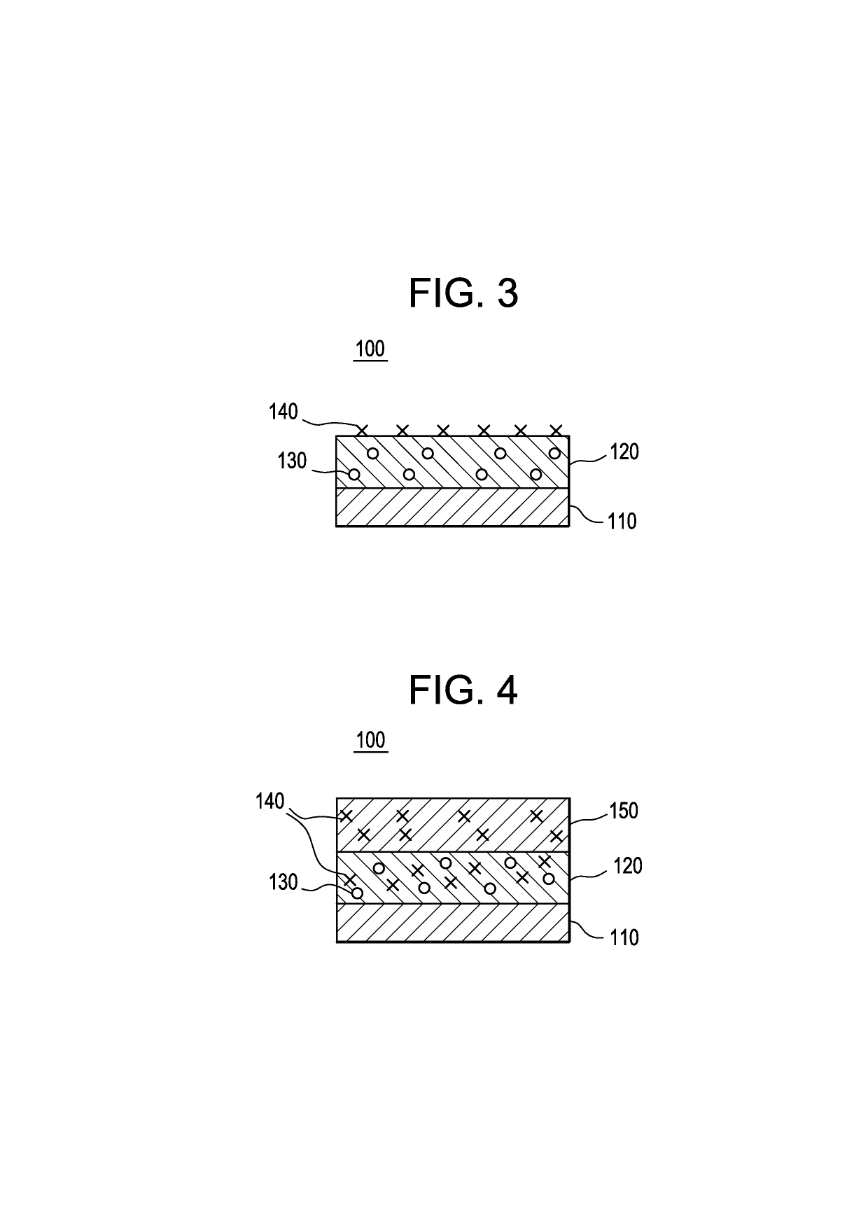

Referring to FIG. 3, in another exemplary embodiment, the radiation inhibitor 140 comprises a gamma radiation absorber disposed on the thermal barrier coating 120 by any conventional means. More specifically, the radiation inhibitor 140 is adsorbed onto the thermal barrier coating 120. In another aspect of the exemplary embodiment, the radiation inhibitor 140 comprising a gamma radiation absorber is disposed in and on the thermal barrier coating 120.

Referring to FIG. 4, in another exemplary embodiment, the radiation inhibitor 140 comprises a radiation inhibitor coating layer 150 disposed on the thermal barrier coating 120 comprising a material wherein the material is a ceramic, glass or a combination of at least one of the foregoing. The radiation inhibitor 140 further comprises a gamma radiation absorber disposed in the thermal barrier coating 120 and a gamma radiation absorber disposed in the radiation inhibitor coating layer 150.

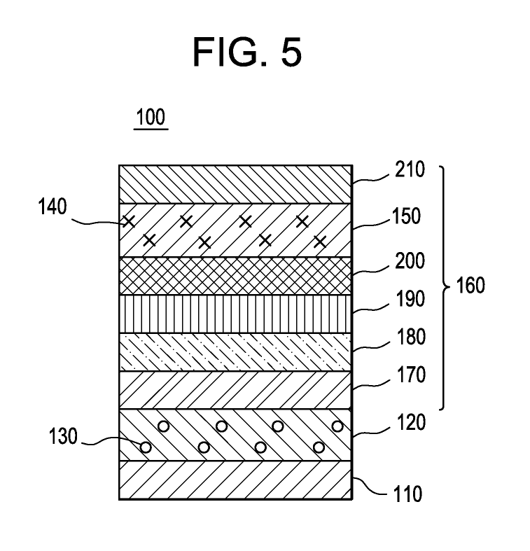

Referring to FIG. 5, in another aspect of the exemplary embodiment, the radiation inhibitor 140 comprising the radiation inhibitor coating layer 150 is disposed in an environmental barrier coating 160 comprising a plurality of layers disposed on the thermal barrier coating 120. The environmental barrier coating 160 comprises a radiation inhibitor coating layer 150 wherein the radiation inhibitor coating layer 150 is a separate or integrated CMAS mitigation layer that comprises a CMAS mitigation composition. The environmental barrier coating 160 further comprises an optional outer layer 200, which is described in further detail below.

In an aspect of the exemplary embodiment, the radiation inhibitor coating layer 150 comprises a separate CMAS mitigating layer comprising a CMAS mitigation composition. The CMAS composition comprises zinc aluminate spinel (ZNAl₂O₄), alkaline earth zirconates (AeZrO₃), alkaline earth hafnates (AeHfO₃), rare earth gallates (Ln₃Ga₅O₁₂, Ln₄Ga₂O₉), beryl, or a combination comprising at least one of the foregoing wherein the CMAS mitigation composition is included as a separate CMAS mitigation layer. As used herein, “separate CMAS mitigation layer” refers to a layer that does not comprise any of the materials of the outer layer 200 on which the radiation inhibitor coating layer 150 is disposed.

In another aspect of the exemplary embodiment, the radiation inhibitor coating layer 150 comprises an integrated CMAS mitigating layer comprising a CMAS mitigation composition. The CMAS mitigation composition comprises zinc aluminate spinel (ZNAl₂O₄), alkaline earth zirconates (AeZrO₃), alkaline earth hafnates (AeHfO₃), hafnium silicate, zirconium silicate, rare earth gallates (Ln₃Ga₅O₁₂, Ln₄Ga₂O₉), rare earth phosphates (LnPO₄), tantalum oxide, beryl, alkaline earth aluminates (AeAl₁₂O19, AeAl₄O₉), rare earth aluminates (Ln₃Al₅O₁₂, Ln₄Al₂O₉), or a combination comprising at least one of the foregoing wherein the CMAS mitigation composition is included as an integrated CMAS layer. As used herein, “integrated CMAS mitigation layer” refers to a layer comprising a CMAS mitigation composition in combination with any materials of the outer layer 200 on which the radiation inhibitor coating layer 150 is disposed.

The environmental barrier coating 160 comprises a silicon bond coat layer 170, an optional silica layer 180, at least one transition layer 190, an optional outer layer 200, a radiation inhibitor coating layer 150 as described above, and an optional abradable layer 210. The silicon bond coat layer 170 comprises a silicon-based material disposed on the thermal barrier coating 120. The silicon bond coat layer 170 acts as an oxidation barrier to prevent oxidation of the substrate 110. The optional silica layer 180 comprises a silica-based material disposed on the silicon bond coat layer 170. The optional silica layer 180 is applied to the silicon bond coat layer 170, or alternatively, is formed naturally or intentionally on the silicon bond coat layer 170. The at least one transition layer 190 is a material comprising mullite, barium strontium aluminosilicate (BSAS), a rare earth disilicate, or a combination of at least one of the foregoing, where the material is disposed on the optional silica layer 180 or the silicon bond coat 170. The transition layer comprises multiple layers, specifically from 1 to 3 layers, where each layer has a thickness of from about 0.1 mils to about 6 mils. The optional outer layer 200 comprises barium strontium aluminosilicate (BSAS), rare earth monosilicates, rare earth disilicates (Ln₂Si₂O₇) or a combination comprising at least one of the foregoing. The optional outer layer 200 has a thickness of from about 0.1 mils to about 40 mils. The optional abradable layer 210 comprises the same material present in a separate CMAS mitigation layer, a rare earth disilicate (Ln₂Si₂O₇) or BSAS. The optional abradable layer 210 can abrade upon impact from an adjacent, rotating engine component. The radiation element 130 in the thermal barrier coating 120 is absorbed by the radiation inhibitor 140 comprising the radiation inhibitor coating layer 150, further comprising a separate or integrated CMAS mitigation layer disposed on the optional outer layer 200. Alternatively, the CMAS mitigation layer comprises a CMAS mitigation composition where the CMAS mitigation layer is disposed on the at least one transition layer 190.

In another aspect of the exemplary embodiment, in the absence of the optional abradable layer 210, the radiation inhibitor coating layer 150 is the outermost layer of the environmental barrier coating 160 disposed on the thermal barrier coating 120.

In another aspect of the exemplary embodiment, the radiation inhibitor 140 further comprises a gamma radiation absorber disposed in the radiation inhibitor coating layer 150 comprising a CMAS mitigation layer, or disposed in the thermal barrier coating 120, or a combination thereof.

In another exemplary embodiment, a method of making a gas turbine engine component comprises providing a gas turbine engine component comprising a high temperature material as a substrate, disposing a thermal barrier coating on the substrate, the thermal barrier coating comprising a radioactive element, the radioactive element having a base radiation emission, disposing a radiation inhibitor in or on the thermal barrier coating, or a combination thereof, the thermal barrier coating and inhibitor having a mitigated radiation emission, wherein the mitigated radiation emission is lower than the base radiation emission. The method is used to produce any of the exemplary embodiments described herein with reference to FIGS. 1-5. The radiation inhibitor is disposed in or on, or in and on, a new thermal barrier coating or an existing thermal barrier coating after a predetermined operating service interval.

The radiation mitigated gas turbine components mitigate or inhibit radiation emitted by radioactive elements in a thermal barrier coating. The radiation mitigated gas turbine engine components can meet industry radiation emission limits. The gas turbine engine components can also provide longer component use between operating service intervals and during the life of the component. The radiation mitigated gas engine turbine components can also be more cost-effective than utilizing pure ceramics in the thermal barrier coating from which radioactive elements have been removed.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An article, comprising:
a substrate;
a thermal barrier coating disposed on the substrate, the thermal barrier coating comprising a radioactive element, wherein the radioactive element has a base radiation emission; and
a radiation inhibitor disposed in or on the thermal barrier coating, or a combination thereof, the thermal barrier coating and radiation inhibitor having a mitigated radiation emission, wherein the mitigated radiation emission is lower than the base radiation emission.

2. The article of claim 1, wherein the inhibitor comprises a coating layer disposed on the thermal barrier coating.

3. The article of claim 2, wherein the coating layer comprises a ceramic or glass, or a combination comprising at least one of the foregoing.

4. The article of claim 3, wherein the ceramic comprises yttria stabilized zirconia, ytterbium zirconate, gadolinium doped yttria stabilized zirconia, or a combination of at least one of the foregoing.

5. The article of claim 3, wherein the ceramic comprises a CMAS mitigation composition.

6. The article of claim 5, wherein the CMAS mitigation composition comprises zinc aluminate spinel, alkaline earth zirconates, alkaline earth hafnates, rare earth gallates or beryl, or a combination comprising at least one of the foregoing.

7. The article of claim 1, wherein the inhibitor comprises an inhibitor material disposed in the thermal barrier coating.

8. The article of claim 7, wherein the inhibitor material comprises a gamma radiation absorber.

9. The article of claim 8, wherein the inhibitor material comprises a gamma radiation absorber having an atomic number equal to or greater than the atomic number of barium.

10. The article of claim 8, wherein the inhibitor material comprises boron, barium, bismuth, hafnium, lead, strontium, tungsten, uranium or a combination comprising at least one of the foregoing.

11. The article of claim 10, wherein the inhibitor material is a compound that further comprises oxygen, nitrogen, carbon, or a combination comprising at least one of the foregoing.

12. The article of claim 1, wherein the radioactive element comprises a radioactive isotope of thorium or uranium, or a combination comprising at least one of the foregoing.

13. The article of claim 1, wherein the article is a power generation device.

14. The article of claim 1, wherein the article is a turbine engine.

15. The article of claim 1, wherein the article is a gas turbine engine.

16. The article of claim 15, wherein the substrate comprises a turbine blade, vane, shroud, liner, combustor, transition piece, rotor component, exhaust flap, seal or fuel nozzle.

17. A method of making an article, comprising:
providing an article comprising a substrate;
disposing a thermal barrier coating on the substrate, the thermal barrier coating comprising a radioactive element, the radioactive element having a base radiation emission; and
disposing a radiation inhibitor in or on the thermal barrier coating, or a combination thereof, the thermal barrier coating and inhibitor having a mitigated radiation emission, wherein the mitigated radiation emission is lower than the base radiation emission.

18. The method of claim 17, wherein disposing the radiation inhibitor comprises forming a coating layer on the thermal barrier coating.

19. The method of claim 18, wherein the coating layer comprises a ceramic, glass, or a combination comprising at least one of the foregoing.

20. The method of claim 17, wherein disposing the radiation inhibitor comprises disposing an inhibitor material in the thermal barrier coating.
